(19) United States
(12) Patent Application Publication
(10) Pub. No.: US 2020/0026646 A1
(43) Pub. Date: Jan. 23, 2020

(54) MEMORY SYSTEM AND OPERATING METHOD THEREOF

(71) Applicant: SK hynix Inc., Gyeonggi-do (KR)

(72) Inventor: Joo-Young LEE, Seoul (KR)

(21) Appl. No.: 16/250,252

(22) Filed: Jan. 17, 2019

(30) Foreign Application Priority Data
Jul. 23, 2018 (KR) 10-2018-0085586

(51) Int. Cl. G06F 12/0804

(52) U.S. Cl. CPC G06F 12/0804; G06F 2212/1032

(57) ABSTRACT

A memory system includes a memory device including a plurality of dies each including one or more flush blocks and one or more multi-level cell blocks; a controller write buffer; a controller buffer manager configured to buffer host data into the controller rite buffer; a flush block manager configured to control, when a flush command is received, the memory device to perform an interleaved program operation of programming the buffered host data into the flush blocks respectively included in the dies; and a processor configured to control, when a size of the buffered host data reaches a threshold value, the memory device to perform the interleaved program operation of programming the buffered host data into the multi-level cell blocks respectively included in the dies.

### CROSS-REFERENCE TO RELATED APPLICATION(S)

The present application claims priority under 35 U.S.C. § 119(a) to Korean Patent Application No. 10-2018-0085586, filed on Jul. 23, 2018, the disclosure of which is incorporated herein by reference in its entirety.

### BACKGROUND

### 1. Field

Various embodiments of the present invention relate to a memory system. Particularly, the embodiments relate to a memory system capable of effectively performing interleaved program operation, and an operating method of the memory system.

### 2. Description of the Related Art

The computer environment paradigm has shifted to ubiquitous computing, which enables computing systems to be used anytime and anywhere. As a result, use of portable electronic devices such as mobile phones, digital cameras, and laptop computers has rapidly increased. These portable electronic devices generally use a memory system having one or more memory devices for storing data. A memory system may be used as a main memory device or an auxiliary memory device of a portable electronic device.

Memory systems provide excellent stability, durability, high information access speed, and low power consumption since they have no moving parts, as compared with a hard disk device. Examples of memory systems having such advantages include universal serial bus (USB) memory devices, memory cards having various interfaces, and solid state drives (SSDs).

### SUMMARY

Various embodiments of the present invention are directed to a memory system may effectively perform an interleaved program operation and an operating method thereof.

In accordance with an embodiment of the present invention, a memory system may include a memory device including a plurality of dies each including one or more flush blocks and one or more multi-level cell blocks; a controller write buffer; a controller buffer manager configured to buffer host data into the controller write buffer; a flush block manager configured to control, when a flush command is received, the memory device to perform an interleaved program operation of programming the buffered host data into the flush blocks respectively included in the dies; and a processor configured to control, when a size of the buffered host data reaches a threshold value, the memory device to perform the interleaved program operation of programming the buffered host data into the multi-level cell blocks respectively included in the dies.

In accordance with an embodiment of the present invention, an operating method of a memory system may include buffering host data into a controller write buffer; performing, when a flush command is received, a first interleaved program operation of programming the buffered host data into a plurality of flush blocks respectively included in a plurality of dies; and performing, when a size of the buffered host data reaches a threshold value, a second interleaved program operation of programming the buffered host data into a plurality of multi-level cell blocks respectively included in the dies.

In accordance with an embodiment of the present invention, the memory system may include a memory device including a plurality of dies, each of the plurality of dies including a plurality of single-level cell (SLC) blocks and a plurality of multi-level cell (MLC) blocks; and a controller, including a write buffer, suitable for: receiving and buffering host data into the write buffer; determining an amount of the buffered host data; when the amount of the buffered host data is less than a threshold value, controlling the memory device to perform an interleaved program operation of programming the buffered host data into the SLC blocks respectively included in the dies; and when the amount of the buffered host data is greater than or equal to the threshold value, controlling the memory device to perform an interleaved program operation of programming the buffered host data into the MLC blocks respectively included in the dies.

In accordance with an embodiment of the present invention, the memory system may promptly perform an interleaved program operation.

### BRIEF DESCRIPTION OF THE DRAWINGS

FIG. 1 is a block diagram illustrating a data processing system including a memory system in accordance with an embodiment of the present invention.

FIG. 2 is a schematic diagram illustrating an exemplary configuration of a memory device employed in the memory system shown in FIG. 1.

FIG. 3 is a circuit diagram illustrating an exemplary configuration of a memory cell array of a memory block in the memory device shown in FIG. 1.

FIG. 4 is a block diagram illustrating an exemplary three-dimensional structure of a memory device of a memory system in accordance with an embodiment of the present invention.

FIG. 5 is a flowchart illustrating a conventional program operation.

FIG. 6 is a schematic diagram that illustrates a concern regarding conventional program delay.

FIG. 7 is a block diagram illustrating a memory system in accordance with an embodiment of the present invention.

FIG. 8 is a transaction flow diagram illustrating an operation of a memory system in accordance with an embodiment of the present invention.

FIG. 9 is a schematic diagram that illustrates a program operation in accordance with an embodiment of the present invention.

FIG. 10 is a schematic diagram that illustrates a program operation in accordance with an embodiment of the present invention.

FIGS. 11 to 19 are diagrams schematically illustrating exemplary applications of a data processing system in accordance with various embodiments of the present invention.

### DETAILED DESCRIPTION

Various embodiments of the present invention are described below in more detail with reference to the accompanying drawings. However, the present invention may be embodied in other forms, which may be variations of any of the described embodiments. Thus, the present invention is not limited to the embodiments set forth herein. Rather, the described embodiments are provided so that this disclosure is thorough and complete and fully conveys the present invention to those skilled in the art to which this invention pertains. Throughout the disclosure, like reference numerals refer to like parts throughout the various figures and embodiments of the present invention. Moreover, throughout the specification, reference to “an embodiment” or the like is not necessarily to only one embodiment, and different references to “an embodiment” or the like are not necessarily to the same embodiment(s).

It will be understood that, although the terms “first”, “second”, “third”, and the like may be used herein to identify various elements, these elements are not limited by these terms. These terms are used to distinguish one element from another element that otherwise have the same or similar names. Thus, a first element described below could also be termed as a second or third element without departing from the spirit and scope of the present invention.

The drawings are not necessarily to scale and, in some instances, proportions may have been exaggerated to clearly illustrate features of the embodiments. When an element is referred to as being connected or coupled to another element, it should be understood that the former can be directly connected or coupled to the latter, or electrically connected or coupled to the latter via one or more intervening elements.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for describing particular embodiments and is not intended to limit the present invention.

As used herein, singular forms are intended to include the plural forms and vice versa, unless the context clearly indicates otherwise.

It will be further understood that the terms “comprises,” “comprising,” “includes,” and “including” when used in this specification, specify the presence of the stated elements but do not preclude the presence or addition of one or more other elements. As used herein, the term “and/or” includes any and all combinations of one or more of the listed items.

Unless otherwise defined, all terms including technical and scientific terms used herein have the same meaning as commonly understood by one of ordinary skill in the art to which the present invention pertains in view of the present disclosure. It will be further understood that terms, such as those defined in commonly used dictionaries, should be interpreted as having a meaning that is consistent with their meaning in the context of the present disclosure and the relevant art and not be interpreted in an idealized or overly formal sense unless expressly so defined herein.

In the following description, numerous specific details are set forth to provide a thorough understanding of the present invention. The present invention may be practiced without some or all of these specific details. In other instances, well-known process structures and/or processes have not been described in detail to not unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

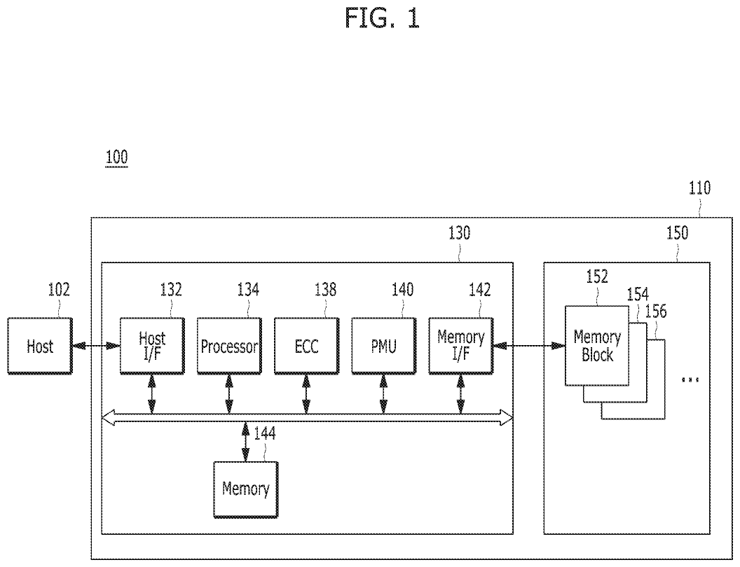

FIG. 1 is a block diagram illustrating a data processing system 100 including a memory system 110 in accordance with an embodiment of the present invention.

Referring to FIG. 1, the data processing system 100 may include a host 102 operatively coupled to the memory system 110.

The host 102 may include any of a variety of portable electronic devices such as a mobile phone, a MP3 player and a laptop computer, or any of a variety of non-portable electronic devices such as a desktop computer, a game machine, a television (TV) and a projector.

The host 102 may include at least one operating system (OS), which may manage and control overall functions and operations of the host 102. The OS may support an operation between the host 102 and a user using the data processing system 100 or the memory system 110. The OS may support functions and operations requested by a user. For example, the OS may be divided into a general OS and a mobile OS, depending on the mobility of the host 102. The general OS may be divided into a personal OS and an enterprise OS, depending on the environment of a user. For example, the personal OS configured to support a function of providing a service to general users may include Windows and Chrome, and the enterprise OS configured to secure and support high performance may include Windows server, Linux and Unix. Furthermore, the mobile OS may be configured to support a function of providing a mobile service to users, and a power saving function of a system may include Android, iOS and Windows Mobile. The host 102 may include a plurality of operating systems. The host 102 may execute an OS to perform an operation corresponding to a user's request on the memory system 110. Here, the host 102 may provide a plurality of commands corresponding to a user's request to the memory system 110. Thus, the memory system 110 may perform certain operations corresponding to the plurality of commands, that is, corresponding to the user's request.

The memory system 110 may store data for the host 102 in response to a request of the host 102. Non-limiting examples of the memory system 110 include a solid state drive (SSD), a multi-media card (MMC), a secure digital (SD) card, a universal storage bus (USB) device, a universal flash storage (UFS) device, a compact flash (CF) card, a smart media card (SMC), a personal computer memory card international association (PCMCIA) card and a memory stick. The MMC may include an embedded MMC (eMMC), a reduced size MMC (RS-MMC) and/or micro-MMC. The SD card may include a mini-SD card and/or micro-SD card.

The memory system 110 may include any of various types of storage devices. Non-limiting examples of such storage devices include volatile memory devices such as a dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM), and a flash memory.

The memory system 110 may include a controller 130 and a memory device 150. The memory device 150 may store data for the host 102, and the controller 130 may control data storage into the memory device 150.

The controller 130 and the memory device 150 may be integrated into a single semiconductor device, which may be included in any of the various types of memory systems as described above. For example, the controller 130 and the memory device 150 may be integrated as a single semiconductor device to constitute an SSD. When the memory system 110 is used as an SSD, the operating speed of the host 102 connected to the memory system 110 can be improved. In another example, the controller 130 and the memory device 150 may be integrated as a single semiconductor device to constitute a memory card such as a personal computer memory card international association (PCMCIA) card, a CompactFlash (CF) card, a smart media card (SMC), a memory stick, a multi-media card (MMC) including a reduced size MMC (RS-MMC) and a micro-MMC, a secure digital (SD) card including a mini-SD, a micro-SD and a SDHC, or an universal flash storage (UFS) device.

The memory device 150 may be a nonvolatile memory device which may retain stored data even though power is not supplied. The memory device 150 may store data provided from the host 102 through a write operation, and output data stored therein to the host 102 through a read operation. In an embodiment, the memory device 150 may include a plurality of memory dies (not shown), and each memory die may include a plurality of planes (not shown). Each plane may include a plurality of memory blocks 152 to 156, each of which may include a plurality of pages, each of which may include a plurality of memory cells coupled to a word line. In an embodiment, the memory device 150 may be a flash memory having a 3-dimensional (3D) stack structure.

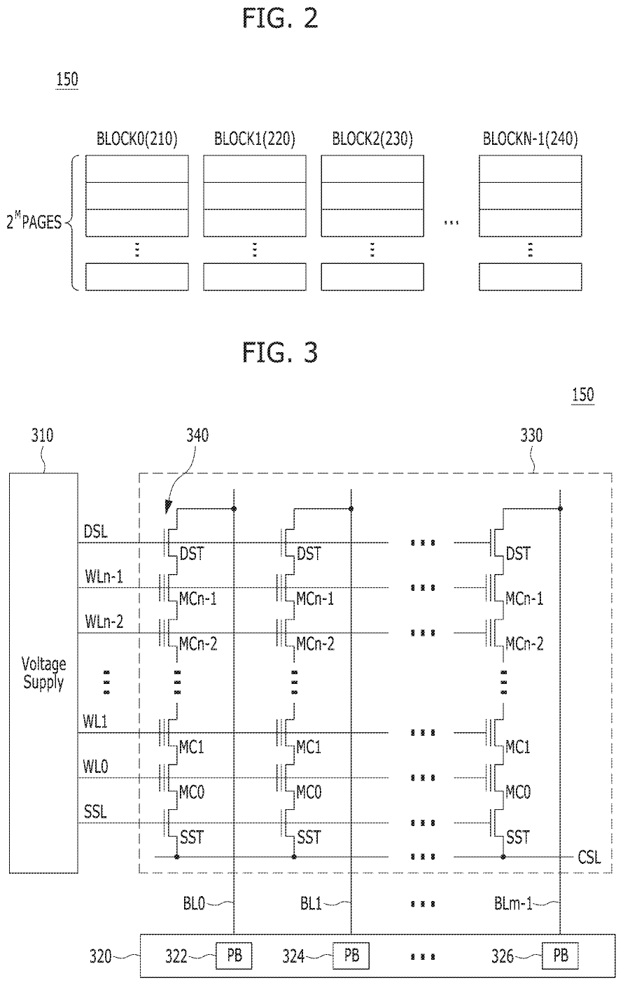

The structure of the memory device 150 and the 3D stack structure of the memory device 150 will be described in detail below with reference to FIGS. 2 to 4.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, write, program and erase operations of the memory device 150.

More specifically, the controller 130 may include a host interface (I/F) 132, a processor 134, an error correction code (ECC) component 138, a power management unit (PMU) 140, a memory interface 142, and a memory 144, all operatively coupled or engaged via an internal bus.

The host interface 132 may process a command and data of the host 102. The host interface 132 may communicate with the host 102 through one or more of various interface protocols such as universal serial bus (USB), multi-media card (MMC), peripheral component interconnect-express (PCI-e or PCIe), small computer system interface (SCSI), serial-attached SCSI (SAS), serial advanced technology attachment (SATA), parallel advanced technology attachment (PATA), enhanced small disk interface (ESDI) and integrated drive electronics (IDE). The host interface 132 may be driven via firmware, that is, a host interface layer (HIL) for exchanging data with the host 102.

Further, the ECC component 138 may correct error bits of data to be processed by the memory device 150 and may include an ECC encoder and an ECC decoder. The ECC encoder may perform error correction encoding on data to be programmed into the memory device 150 to generate data to which a parity bit is added. The data including the parity bit may be stored in the memory device 150. The ECC decoder may detect and correct an error contained in the data read from the memory device 150. In other words, the ECC component 138 may perform an error correction decoding process to the data read from the memory device 150 through an ECC code used during an ECC encoding process. According to a result of the error correction decoding process, the ECC component 138 may output a signal, for example, an error correction success or fail signal. When the number of error bits is more than a threshold value of correctable error bits, the ECC component 138 may not correct the error bits, and instead may output the error correction fail signal.

The ECC component 138 may perform error correction through a coded modulation such as a low density parity check (LDPC) code, a Bose-Chaudhri-Hocquenghem (BCH) code, a turbo code, a Reed-Solomon (RS) code, a convolution code, a recursive systematic code (RSC), a trellis-coded modulation (TCM) and a block coded modulation (BCM). However, the ECC component 138 is not limited to these error correction techniques. As such, the ECC component 138 may include any and all circuits, modules, systems or devices for performing suitable error correction.

The PMU 140 may manage electrical power used and provided in the controller 130.

The memory interface 142 may serve as a memory/storage interface between the controller 130 and the memory device 150 such that the controller 130 may control the memory device 150 in response to a request from the host 102.

The memory 144 may serve as a working memory of the memory system 110 and the controller 130, and store data for driving the memory system 110 and the controller 130. The controller 130 may control the memory device 150 to perform read, program, and erase operations in response to a request from the host 102. The controller 130 may provide data read from the memory device 150 to the host 102, and may store data provided from the host 102 into the memory device 150. The memory 144 may store data required for the controller 130 and the memory device 150 to perform these operations.

The memory 144 may be a volatile memory. For example, the memory 144 may be a static random access memory (SRAM) or dynamic random access memory (DRAM). The memory 144 may be disposed within or external to the controller 130. FIG. 1 shows the memory 144 disposed within the controller 130. In another embodiment, the memory 144 may be an external volatile memory having a memory interface for transferring data between the memory 144 and the controller 130.

As described above, the memory 144 may include a program memory, a data memory, a write buffer/cache, a read buffer/cache, a data buffer/cache and a map buffer/cache to store some data required to perform data write and read operations between the host 102 and the memory device 150 and other data required for the controller 130 and the memory device 150 to perform these operations.

The processor 134 may control overall operations of the memory system 110. The processor 134 may use firmware to control the overall operations of the memory system 110. The firmware may be referred to as flash translation layer (FTL).

For example, the controller 130 may perform an operation requested by the host 102 in the memory device 150 through the processor 134, which is implemented as a microprocessor, a CPU, or the like. Also, the controller 130 may perform a background operation on the memory device 150 through the processor 134, which may be realized as a microprocessor or a CPU. The background operation performed on the memory device 150 may include an operation of copying and processing data stored in some memory blocks among the memory blocks 152 to 156 of the memory device 150 into other memory blocks, e.g., a garbage collection (GC) operation, an operation of swapping data between select memory blocks of the memory blocks 152 to 156, e.g., a wear-leveling (WL) operation, an operation of storing the map data stored in the controller 130 in the memory blocks 152 to 156, e.g., a map flush operation, or an operation of managing bad blocks of the memory device 150, e.g., a bad block management operation of detecting and processing bad blocks among the memory blocks 152 to 156 in the memory device 150.

The memory device of the memory system in accordance with an embodiment of the present invention is described in detail with reference to FIGS. 2 to 4.

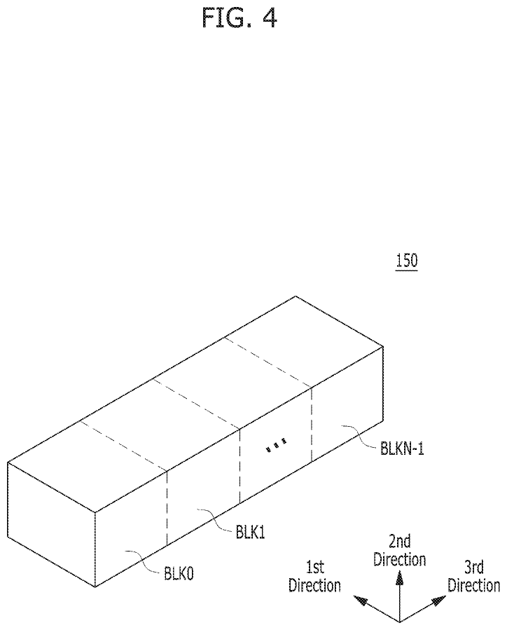

FIG. 2 is a schematic diagram illustrating the memory device 150 of the memory system 110 in FIG. 1. FIG. 3 is a circuit diagram illustrating an exemplary configuration of a memory cell array of a memory block 330 representative of any of the memory blocks 152, 154, 156 in the memory device 150. FIG. 4 is a schematic diagram illustrating an exemplary three-dimensional (3D) structure of the memory device 150.

Referring to FIG. 2, the memory device 150 may include a plurality of memory blocks BLOCK0 to BLOCKN−1, where N is an integer greater than 1. Each of the blocks BLOCK0 to BLOCKN−1 may include a plurality of pages, for example, 2N^{M} or M pages, the number of which may vary according to circuit design, M being an integer greater than 1. Each of the pages may include a plurality of memory cells that are coupled to a plurality of word lines WL.

Memory cells in the respective memory blocks BLOCK0 to BLOCKN−1 may be one or more of a single level cell (SLC) storing 1-bit data or a multi-level cell (MLC) storing 2 of more bits data. Hence, the memory device 150 may include SLC memory blocks or MLC memory blocks, depending on the number of bits which can be expressed or stored in each of the memory cells in the memory blocks. The SLC memory blocks may include a plurality of pages which are embodied by memory cells, each storing one-bit data. The SLC memory blocks may generally have higher data computing performance and higher durability than the MCL memory blocks. The MLC memory blocks may include a plurality of pages which are embodied by memory cells each storing multi-bit data (for example, 2 or more bits). The MLC memory blocks may generally have larger data storage space, that is, higher integration density, than the SLC memory blocks. MLCs may also include triple level cells (TLC), each of which may store 3 bits of data, and quadruple level cells (QLC), each of which may store 4 bits of data. Thus, in another embodiment, the memory device 150 may include a plurality of triple level cell (TLC) memory blocks that may include a plurality of pages embodied by TLCs. In yet another embodiment, the memory device 150 may include a plurality of quadruple level cell (QLC) memory blocks that may include a plurality of pages embodied by QLCs.

Instead of a nonvolatile memory, the memory device 150 may implemented by any one of a phase change random access memory (PCRAM), a resistive random access memory (RRAM or ReRAM), a ferroelectrics random access memory (FRAM), and a spin transfer torque magnetic random access memory (STT-RAM).

The memory blocks 210, 220, 230, 240 may store the data transferred from the host 102 through a program operation, and may transfer data stored therein to the host 102 through a read operation.

Referring to FIG. 3, the memory block 330 may include a plurality of cell strings 340 coupled to a plurality of corresponding bit lines BL0 to BLm−1. The cell string 340 of each column may include one or more drain select transistors DST and one or more source select transistors SST. Between the drain and source select transistors DST and SST, a plurality of memory cells MC0 to MCn−1 may be coupled in series. In an embodiment, each of the memory cell transistors MC0 to MCn−1 may be embodied by an MLC capable of storing data information of a plurality of bits. Each of the cell strings 340 may be electrically coupled to a corresponding bit line among the plurality of bit lines BL0 to BLm−1. For example, as illustrated in FIG. 3, the first cell string is coupled to the first bit line BL0, and the last cell string is coupled to the last bit line BLm−1.

Although FIG. 3 illustrates NAND flash memory cells, the present disclosure is not limited thereto. It is noted that the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply 310 which generates different word line voltages including a program voltage, a read voltage, and a pass voltage to supply to the word lines according to an operation mode. The voltage generation operation of the voltage supply 310 may be controlled by a control circuit (not illustrated). Under the control of the control circuit, the voltage supply 310 may select at least one of the memory blocks (or sectors) of the memory cell array, select at least one of the word lines of the selected memory block, and provide the word line voltages to the selected word line(s) and the unselected word lines as may be needed.

The memory device 150 may include a read/write circuit 320 which is controlled by the control circuit. During a verification/normal read operation, the read/write circuit 320 may operate as a sense amplifier for reading (sensing and amplifying) data from the memory cell array. During a program operation, the read/write circuit 320 may operate as a write driver for supplying a voltage or a current to bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs). Each of the page buffers 322 to 326 may include a plurality of latches (not illustrated).

The memory device 150 may be embodied by a 2D or 3D memory device. Particularly, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN−1. FIG. 4 is a block diagram illustrating the memory blocks 152, 154 and 156 of the memory device 150 shown in FIG. 1. Each of the memory blocks 152, 154 and 156 may be realized in a 3D structure (or vertical structure). For example, the memory blocks 152, 154 and 156 may be a three-dimensional structure with dimensions extending in three mutually orthogonal directions, e.g., an x-axis direction, a y-axis direction, and a z-axis direction, as shown in FIG. 4.

Each memory block 330 included in the memory device 150 may include a plurality of NAND strings NS extending in the second direction, and a plurality of NAND strings NS extending in the first direction and the third direction. Herein, each of the NAND strings NS may be coupled to a bit line BL, at least one string selection line SSL, at least one ground selection line GSL, a plurality of word lines WL, at least one dummy word line DWL, and a common source line CSL, and each of the NAND strings NS may include a plurality of transistor structures TS.

In short, each memory block 330 of the memory device 150 may be coupled to a plurality of bit lines BL, a plurality of string selection lines SSL, a plurality of ground selection lines GSL, a plurality of word lines WL, a plurality of dummy word lines DWL, and a plurality of common source lines CSL, and each memory block 330 may include a plurality of NAND strings NS. Also, in each memory block 330, one bit line BL may be coupled to a plurality of NAND strings NS to realize a plurality of transistors in one NAND string NS. Also, a string selection transistor SST of each NAND string NS may be coupled to a corresponding bit line BL, and a ground selection transistor GST of each NAND string NS may be coupled to a common source line CSL. Herein, memory cells MC may be provided between the string selection transistor SST and the ground selection transistor GST of each NAND string NS. In other words, a plurality of memory cells may be realized in each memory block 330.

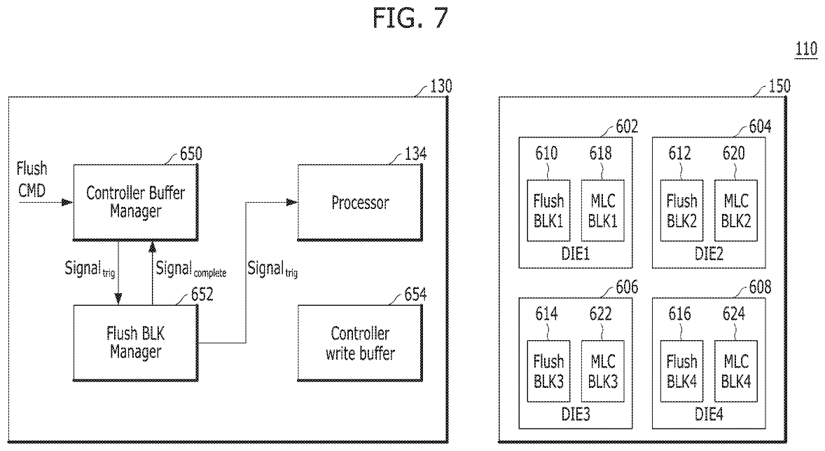

Referring again to FIG. 1, the controller 130 may control the memory device 150 to program therein all of host data, which are buffered in a controller write buffer included in the controller 130 in response to a flush command. The controller write buffer is shown in FIG. 7 and described in more detail below with reference to that figure. Here, to simplify the description, the controller write buffer is referred to as a buffer. In response to the flush command, the controller 130 may control the memory device 150 to program (e.g., one-shot-program) the host data into a block (e.g., a multi-level cell block), even when the size of the host data buffered in the buffer is less than the capacity of a page of a multi-level cell (or a multi-level cell page). In order to one-shot program data into the block of the multi-level cell, the size of the host data buffered in the buffer should be the same as the capacity of the multi-level cell page. Therefore, when the size of the host data buffered in the buffer is greater than the capacity of a single-level cell page and less than the capacity of a multi-level cell page at the time when the flush command is provided, the controller 130 may control, in response to the flush command, the memory device 150 to one-shot-program the host data in the buffer into the multi-level cell page. In other words, the controller 130 may control the memory device 150 to one-shot-program the buffered host data along with dummy data into the multi-level cell page.

When the host data in the buffer is one-shot-programmed along with dummy data into the multi-level cell page whenever the flush command is provided, it is possible to one-shot program the buffered host data in response to the flush command. However, a significant amount of dummy data may be programmed into memory blocks in a workload of highly frequent flush commands. The dummy data are merely used for the one-shot-programming of the host data in the buffer into the multi-level cell page in response to the flush command and thus do not have any meaningful information required for the controller 130. As a result, storage space in the memory device 150 is wasted due to such use of the dummy data. The situation is exacerbated when the memory device 150 has limited storage space, which is often the case.

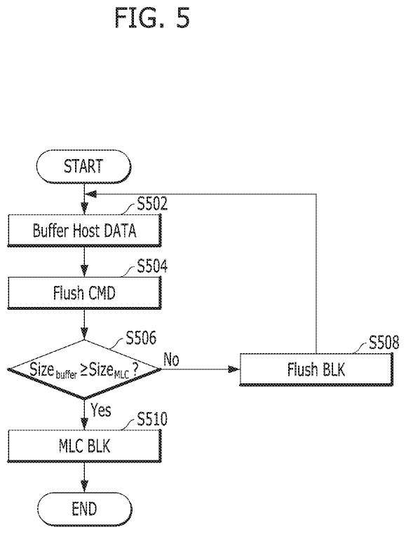

FIG. 5 is a flowchart illustrating a conventional program operation.

Referring to FIG. 5, at step S502, the controller 130 buffers host data, which is provided from the host 102, into a buffer. The controller 130 removes the host data from the buffer after such data is programmed into the multi-level cell page of the memory device 150.

At step S504, the controller 130 checks the size of the host data in the buffer in response to a flush command provided from the host 102. The provision frequency of the flush command is different depending on a workload.

At step S506, the controller 130 determines whether the size of the host data in the buffer (i.e., Size_{buffer}) reaches (or is greater than or equal to) the capacity of the multi-level cell page (i.e., Size_{MLC}).

At step S508, when the decision is “No” at step S506, the controller 130 controls the memory device 150 to program the host data in the buffer into a flush block. The flush block is a single-level cell block. Even when the buffered host data is programmed into the flush block, the host data are kept in the buffer.

At step S510, when the decision is “Yes” at step S506, the controller 130 controls the memory device 150 to one-shot program the host data in the buffer into a multi-level cell page. The multi-level cell page is any multi-level cell (MLC) page, including a triple-level cell (TLC) page and a quadruple-level cell (QLC) page. The controller 130 removes the host data from the buffer after the host data is programmed into the multi-level cell page.

As described above, even when the host data in the buffer is greater than the capacity of a single-level cell page and less than the capacity of a multi-level cell page at the time when the flush command is provided, the controller 130 does not control the memory device 150 to one-shot-program the host data in the buffer along with dummy data into the multi-level cell page in response to the flush command. The controller 130 controls the memory device 150 to first program the host data in the buffer into the flush block in response to the flush command. Then, when the size of the buffered host data reaches the capacity of the multi-level cell page, the controller 130 controls the memory device 150 to one-shot-program the host data into the multi-level cell page.

The flush block prevents a significant amount of dummy data from being programmed into the memory device 150 in the case of a workload of highly frequent flush commands. However, in the case where the controller 130 controls the memory device 150 to one-shot program the host data in the buffer into the multi-level cell page only when the size of the buffered host data buffered reaches the capacity of the multi-level cell page, there may occur a case that the controller 130 has to control, in response to a subsequently provided flush command, the memory device 150 to program the host data in the buffer into the flush block in the same die as the multi-level cell page while one-shot-programming the host data in the buffer into the multi-level cell page. When the multi-level cell page and the flush block are in the same die, the controller 130 cannot control, in response to the subsequently provided flush command, the memory device 150 to program the host data in the buffer into the flush block in the same die as the multi-level cell page. The controller 130 has to wait for controlling, in response to the subsequently provided flush command, the memory device 150 to program the buffered host data into the flush block in the same die as the multi-level cell page until the memory device 150 completes one-shot-programming the host data in the buffer into the multi-level cell page. The waiting for programming the buffered host data buffered into the flush block in the same die as the multi-level cell page delays the program operation of the memory device 150.

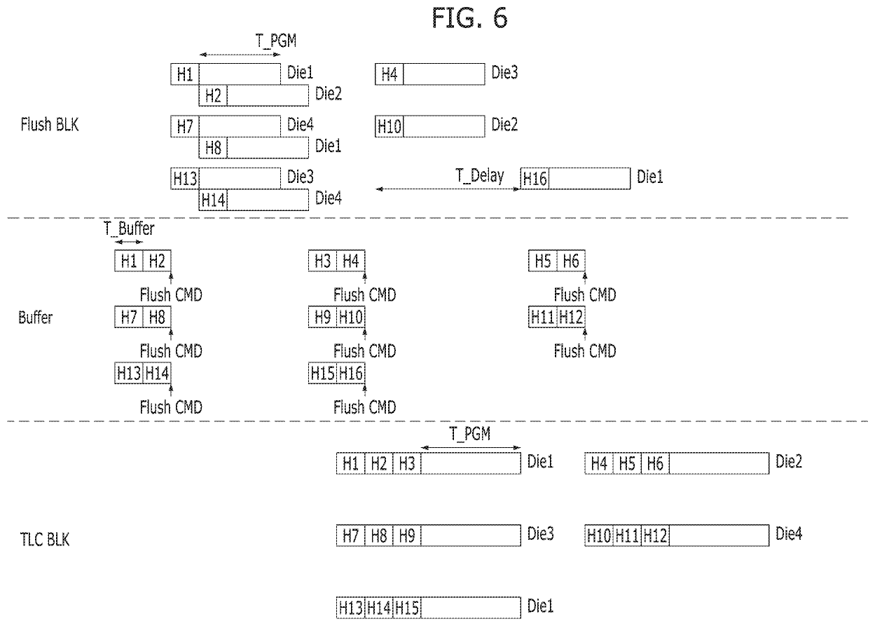

FIG. 6 illustrates program delay during a conventional program operation.

In FIG. 6, it is assumed that the size of each piece of host data is the same as the capacity of a single level cell page. It is also assumed that a flush command is provided each time the size of host data in the buffer becomes twice the capacity of the single level cell page. It is further assumed that the multi-level cell is a triple level cell (TLC) and the number of dies included in the memory device 150 is four (4).

When first data H1 and second data H2 are buffered into the buffer and a flush command Flush CMD is provided from the host 102, the controller 130 controls the memory device 150 to program the first data H1 and second data H2 into flush blocks in first and second dies, respectively. The controller 130 controls the memory device 150 to program the first data H1 into a flush block in the first die while programming the second data H2 into a flush block in the second die according to the interleaved program scheme. As described above, the first data H1 and second data H2 are kept buffered in the buffer even when they are programmed into the flush blocks. The controller 130 buffers third host data H3 into the buffer after completion of the programming of the first data H1 and second data H2.

When the size of the buffered first data H1, second data H2 and third host data H3 reaches the capacity of the triple level cell page, as the third host data H3 is buffered into the buffer, the controller 130 controls the memory device 150 to one-shot-program the first data H1, second data H2 and third host data H3 into the triple level cell page in the first die Die1.

After the one-shot-program operation of the first data H1, second data H2 and third host data H3 into the triple level cell page, the controller 130 removes the first data H1, second data H2 and third host data H3 from the buffer. Therefore, as described later, when a fourth host data H4 is subsequently buffered into the buffer and another flush command Flush CMD is provided from the host 102, the controller 130 controls the memory device 150 to program the fourth host data H4 into a flush block included in a third die Die3 since the first data H1, second data H2 and third host data H3 are already removed from the buffer.

When the fourth host data H4 is subsequently buffered into the buffer and another flush command Flush CMD is provided from the host 102 during the one-shot-program operation of the first data H1, second data H2 and third host data H3 into the triple level cell page in the first die Die1, the controller 130 controls the memory device 150 to program the fourth host data H4 into the flush block in the third die Die3.

The controller 130 repeats the above-described operation with fifth to fourteenth host data H5 to H14. When the size of the buffered thirteenth to fifteenth host data H13 to H15 reaches the capacity of the triple level cell page, as the fifteenth host data H15 is buffered into the buffer, the controller 130 controls the memory device 150 to one-shot-program the thirteenth to fifteenth host data H13 to H15 into the triple level cell page in the first die Die1. When the sixteenth host data H16 is subsequently buffered into the buffer and another flush command Flush CMD is provided from the host 102 during the one-shot-program operation of the thirteenth to fifteenth host data H13 to H15 into the triple level cell page in the first die Die1, the controller 130 controls the memory device 150 to program the sixteenth host data H16 into the flush block in the first die Die1. As described above, when the triple level cell page and the flush block are included in the same die (i.e., the first die Die1), the controller 130 cannot control, in response to the subsequently provided flush command Flush CMD, the memory device 150 to program the sixteenth host data H16 buffered in the buffer into the flush block in the same die (i.e., the first die Die1) as the triple level cell page. The controller 130 has to wait for controlling, in response to the subsequently provided flush command Flush CMD, the memory device 150 to program the sixteenth host data H16 buffered in the buffer into the flush block in the same die (i.e. the first die Die1) as the triple level cell page until the memory device 150 completes one-shot-programming the thirteenth to fifteenth host data H13 to H15 in the buffer into the triple level cell page included in the first die Die1.

In the case where the controller 130 controls the memory device 150 to one-shot-program the host data buffered in the buffer into the multi-level cell page only when the size of the host data buffered in the buffer reaches the capacity of the multi-level cell page, there may occur a case in which the controller 130 has to control, in response to a subsequently provided flush command, the memory device 150 to program the buffered host data into the flush block in the same die as the multi-level cell page while one-shot programming the host data in the buffer into the multi-level cell page. When the multi-level cell page and the flush block are included in the same die, the controller 130 cannot control, in response to the subsequently provided flush command, the memory device 150 to program the buffered host data buffered into the flush block in the same die as the multi-level cell page. The controller 130 has to wait for controlling, in response to the subsequently provided flush command, the memory device 150 to program the host data in the buffer into the flush block in the same die as the multi-level cell page until the memory device 150 completes one-shot-programming the host data in the buffer into the multi-level cell page. The waiting for such programming causes a delay time T_Delay that the program operation of the memory device 150 is delayed.

In accordance with an embodiment of the present invention, when the size of the host data buffered in the buffer reaches an amount equal to the number of dies in the memory device 150 multiplied by the capacity of the multi-level cell page, the controller 130 may control the memory device 150 to perform the interleaved program operation of programming the buffered host data into the multi-level cell pages. Therefore, such action may prevent delay of the program operation of programming the subsequent host data into the flush block in the same die as the multi-level cell page, into which the one-shot-program operation of programming previous host data is being performed.

FIG. 7 is a block diagram illustrating a memory system 110 in accordance with an embodiment of the present invention. FIG. 7 shows elements related with an embodiment of the present invention in the data processing system 100 described with reference to FIG. 1.

As described above, the memory system 110 may include the memory device 150 and the controller 130. The controller 130 may control the memory device 150 to store host data, which is provided from the host 102, into the memory blocks included therein. The controller 130 may also control the interleaved program operation of the memory device 150.

Referring to FIG. 7, the controller 130 may further include a processor 134, a controller buffer manager 650, a flush block (BLK) manager 652 and a controller write buffer 654. The memory device 150 may include a plurality of dies. For example, the memory device 150 may include first to fourth dies DIE1 602, DIE2 604, DIE3 606 and DIE4 608. Each of the first to fourth dies 602, 604, 606 and 608 may include a flush block (i.e., Flush BLK) and a multi-level cell block (i.e., MLC BLK). For example, the flush block may be the single level cell (SLC) block.

The controller buffer manager 650 may buffer the host data into the controller write buffer 654. The controller write buffer 654 may be implemented with a volatile memory and may be configured to buffer data required for a program operation and a read operation between the host 102 and the memory device 150. The controller buffer manager 650 may provide a trigger signal Signal_{trig} to the flush block manager 652 whenever the flush command Flush CMD is provided from the host 102.

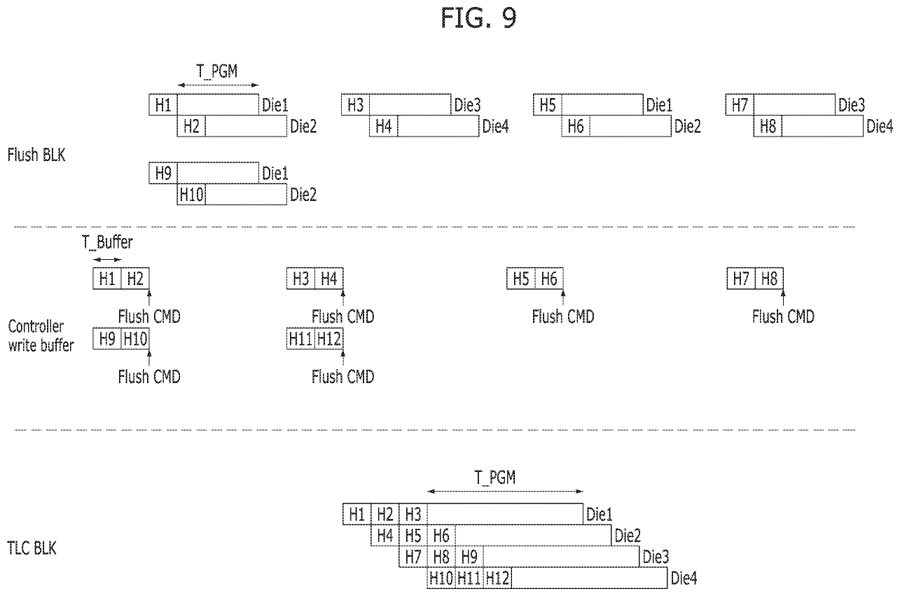

The flush block manager 652 may measure the size of the host data buffered in the controller write buffer 654 and may compare the measured size of the buffered host data with a threshold value, whenever the trigger signal Signal_{trig} is provided. In accordance with an embodiment of the present invention, the threshold value may be the number of dies in the memory device 150 multiplied by the capacity of the multi-level cell page. For example, when the number of dies in the memory device 150 is four (4), the threshold value may be the quadruple of the capacity of the multi-level cell page. As described later with reference to FIG. 9, when the size of the host data buffered in the controller write buffer 654 reaches the threshold value, the controller 130 may control the memory device 150 to program the buffered host data into the multi-level cell block. Therefore, the speed of the program operation of the memory system 110 may be improved by preventing the delay of the program operation of programming, in response to a subsequent flush command Flush CMD, the subsequent host data into the flush block included in the same die as the multi-level cell block, into which the program operation of programming previous host data is being performed.

In accordance with an embodiment of the present invention, when the capacity of the controller write buffer 654 is greater than a multiple of the product of the number of dies in the memory device 150 and the capacity of the multi-level cell page, the threshold value may be the multiple of the product of the number of the dies in the memory device 150 and the capacity of the multi-level cell page. For example, when the number of dies in the memory device 150 is four (4) and the capacity of the controller write buffer 654 is greater than a double of the quadruple (i.e., the octuple) of the capacity of the multi-level cell page, the threshold value may be the octuple of the capacity of the multi-level cell page.

When the measured size of the host data buffered in the controller write buffer 654 is less than the threshold value, the flush block manager 652 may control the memory device 150 to perform the interleaved program operation of programming the buffered host data into first to fourth flush blocks 610, 612, 614 and 616 respectively in the first to fourth dies 602, 604, 606 and 608. For example, when the measured size of the host data buffered in the controller write buffer 654 is double the capacity of the single level cell page, the flush block manager 652 may control memory device 150 to perform the interleaved program operation of programming a part of the buffered host data into the first flush block 610 in the first die 602 while programming remaining buffered host data into the second flush block 612 in the second die 604.

Upon completion of the interleaved program operation, the flush block manager 652 may provide a completion signal Signal_{complete} to the controller buffer manager 650. The controller buffer manager 650 and the flush block manager 652 may repeat the operation of buffering the host data into the controller write buffer 654 and the interleaved program operation until the size of the host data buffered in the controller write buffer 654 reaches the threshold value. When the size of the host data buffered in the controller write buffer 654 reaches the threshold value, the flush block manager 652 may provide the trigger signal Signal_{trig} to the processor 134.

In response to the trigger signal Signal_{trig}, the processor 134 may control the memory device 150 to perform the interleaved program operation of programming the host data buffered in the controller write buffer 654 into first to fourth multi-level cell blocks 618, 620, 622 and 624 respectively in the first to fourth dies 602, 604, 606 and 608. For example, the processor 134 may divide the host data buffered in the controller write buffer 654 into first to fourth groups. The processor 134 may control the memory device 150 to perform the interleaved program operation of programming the first to fourth groups into the first to fourth multi-level cell blocks 618, 620, 622 and 624 of the first to fourth dies 602, 604, 606 and 608, respectively.

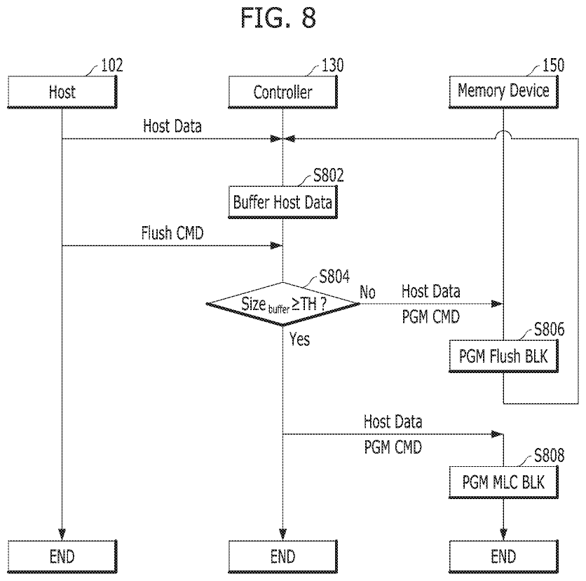

FIG. 8 is a transaction flow illustrating an operation of a memory system, e.g., the memory system 110 of FIG. 7, in accordance with an embodiment of the present invention.

Referring to FIG. 8, at step S802, the controller 130 may buffer the host data, which is provided from the host 102, into the controller write buffer 654. The controller write buffer 654 may be implemented with a volatile memory and may be configured to buffer data for a program operation and a read operation between the host 102 and the memory device 150.

At step S804, whenever the flush command Flush CMD is provided from the host 102, the controller 130 may determine whether the size of the host data in the controller write buffer 654 (i.e., Size_{buffer}) reaches the threshold value TH. In accordance with an embodiment of the present invention, the threshold value TH may be a product of the number of dies in the memory device 150 and the capacity of the multi-level cell page. In accordance with an embodiment of the present invention, when the capacity of the controller write buffer 654 is greater than a multiple of the product of the number of dies in the memory device 150 and the capacity of the multi-level cell page, the threshold value TH may be a multiple of that product. For example, when the number of dies in the memory device 150 is four (4) and the capacity of the controller write buffer 654 is greater than double of the quadruple (i.e., the octuple) of the capacity of the multi-level cell page, the threshold value TH may be the octuple of the capacity of the multi-level cell page.

At step S806, when the size of the host data buffered in the controller write buffer 654 is less than the threshold value TH (“No” at step S804), the controller 130 may provide host data and a program command (i.e., PGM CMD) to the memory device 150. The memory device 150 may perform the interleaved program operation in response to the program command. The interleaved program operation programs the provided host data into the first to fourth flush blocks 610, 612, 614 and 616 respectively included in the first to fourth dies 602, 604, 606 and 608. For example, when the size of the host data buffered in the controller write buffer 654 is double the capacity of the single level cell page, the controller 130 may control the memory device 150 to perform the interleaved program operation of programming a portion of the buffered host data into the first flush block 610 in the first die 602 while programming the remaining portion of the buffered host data into the second flush block 612 in the second die 604. As described above, even when the host data buffered in the controller write buffer 654 is programmed into the first to fourth flush blocks 610, 612, 614 and 616, the host data are kept buffered in the controller write buffer 654. The controller 130 may repeat steps S802 to S806 until the size of the host data buffered in the controller write buffer 654 reaches the threshold value TH.

At step S808, when the size of the host data buffered in the controller write buffer 654 reaches the threshold value TH (“YES” at step S804), the controller 130 may provide host data and a program command (i.e., PGM CMD) to the memory device 150. In response to the program command, the memory device 150 may perform the interleaved program operation of programming the provided host data into the first to fourth multi-level cell blocks 618, 620, 622 and 624 respectively included in the first to fourth dies 602, 604, 606 and 608. For example, the controller 130 may divide the host data buffered in the controller write buffer 654 into first to fourth groups. The controller 130 may control the memory device 150 to perform the interleaved program operation of programming the first to fourth groups into the first to fourth multi-level cell blocks 618, 620, 622 and 624 of the first to fourth dies 602, 604, 606 and 608, respectively.

In accordance with an embodiment of the present invention, when the size of the host data buffered in the controller write buffer 654 reaches the product of the number of dies in the memory device 150 and the capacity of the multi-level cell page, the memory system 110 may program the buffered host data into the multi-level cell blocks. The controller 130 may divide the host data buffered in the controller write buffer 654 into the first to fourth groups. The controller 130 may control the memory device 150 to perform the interleaved program operation of programming the first to fourth groups into the first to fourth multi-level cell blocks 618, 620, 622 and 624 of the first to fourth dies 602, 604, 606 and 608, respectively, thereby improving the speed of the program operation.

FIG. 9 illustrates a program operation in accordance with an embodiment of the present invention.

As is the case in connection with the description of FIG. 6, here it is assumed that the size of each piece of host data is the same as the capacity of a single level cell page. It is also assumed that a flush command Flush CMD is provided each time the size of host data buffered in the controller write buffer 654 becomes twice the capacity of the single level cell page. It is further assumed that the multi-level cell is a triple level cell (TLC) and the number of dies in the memory device 150 is four (4).

When first data H1 and second data H2 are buffered into the controller write buffer 654 and the flush command Flush CMD is provided from the host 102, the controller 130 controls the memory device 150 to perform the interleaved program operation of programming the first data H1 and second data H2 into the first and second flush blocks 610 and 612 included in the first and second dies 602 and 604, respectively. The controller 130 repeats above-described operation with third to tenth host data H3 to H10. When the size of the first to twelfth host data H1 to H12 reaches the threshold value TH or the product of the number of dies in the memory device 150 and the capacity of the triple level cell page, as the eleventh and twelfth host data H11 and H12 are buffered into the controller write buffer 654, the controller 130 controls the memory device 150 to perform the interleaved program operation of programming the buffered first to twelfth host data H1 to H12 into the first to fourth triple level cell blocks 618, 620, 622 and 624 respectively included in the first to fourth dies 602, 604, 606 and 608.

In accordance with an embodiment of the present invention, when the size of the host data in the controller write buffer 654 reaches the threshold value TH or the product of the number of dies in the memory device 150 and the capacity of the triple level cell page, the memory system 110 may perform the interleave program operation of programming the buffered host data into the memory device 150. In that case, the controller 130 may divide the buffered host data into the number of dies in the memory device 150 and may control the memory device 150 to perform the interleaved program operation of one-shot programming the divided groups of host data into the first to fourth triple level cell blocks 618, 620, 622 and 624 respectively included in the first to fourth dies 602, 604, 606 and 608, thereby improving the speed of the program operation.

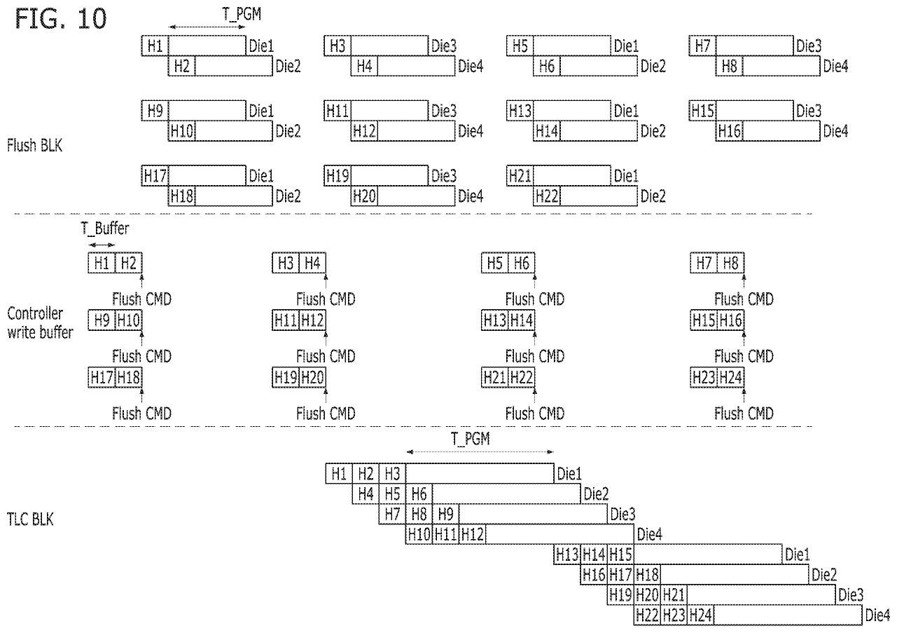

FIG. 10 illustrates a program operation in accordance with an embodiment of the present invention.

Here, it is again assumed that the size of each piece of host data is the same as the capacity of a single level cell page. It is also assumed that a flush command Flush CMD is provided each time the size of host data buffered in the controller write buffer 654 becomes twice the capacity of the single level cell page. It is further assumed that the multi-level cell is a triple level cell (TLC) and the number of dies in the memory device 150 is four (4). It is further assumed that the capacity of the controller write buffer 654 is greater than double of the multiplication of the number of dies in the memory device 150 and the capacity of the triple level cell page.

When first data H1 and second data H2 are buffered into the controller write buffer 654 and the flush command Flush CMD is provided from the host 102, the controller 130 controls the memory device 150 to perform the interleaved program operation of programming the first data H1 and second data H2 into the first and second flush blocks 610 and 612 in the first and second dies 602 and 604, respectively. The controller 130 repeats above-described operation with third to twenty-second host data H3 to H22. When the size of the first to twenty-fourth host data H1 to H24 reaches the threshold value TH or double the product of the number of dies in the memory device 150 and the capacity of the triple level cell page, as the twenty-third and twenty-fourth host data H23 and H24 are buffered into the controller write buffer 654, the controller 130 controls the memory device 150 to perform the interleaved program operation of programming the buffered first to twenty-fourth host data H1 to H24 into the first to fourth triple level cell blocks 618, 620, 622 and 624 respectively included in the first to fourth dies 602, 604, 606 and 608.

In accordance with an embodiment of the present invention, in the case where the capacity of the controller write buffer 654 is greater than a multiple of the product of the number of dies in the memory device 150 and the capacity of the triple level cell page, when the size of the host data in the controller write buffer 654 reaches the threshold value TH or a multiple of the product of the number of dies in the memory device 150 and the capacity of the triple level cell page, the controller 130 may control the memory device 150 to perform the interleaved program operation of one-shot-programming the buffered host data into the first to fourth triple level cell blocks 618, 620, 622 and 624 respectively included in the first to fourth dies 602, 604, 606 and 608. In the case where the capacity of the controller write buffer 654 is greater than a multiple of the product of the number of dies in the memory device 150 and the capacity of the triple level cell page, the controller 130 may control the memory device 150 to perform the interleaved program operation of one-shot programming the host data into the first to fourth triple level cell blocks 618, 620, 622 and 624 respectively included in the first to fourth dies 602, 604, 606 and 608. Here, the size of the host data may be greater than the product of the number of dies in the memory device 150 and the capacity of the triple level cell page. Thus, the controller 130 may improve the speed of the program operation.

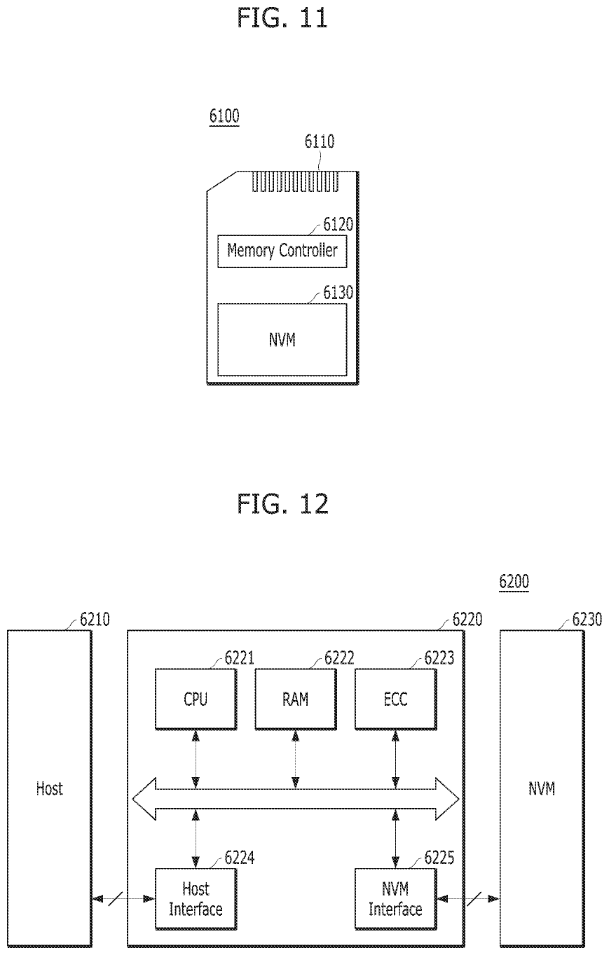

A data processing system and electronic devices to which the memory system 110 including the memory device 150 and the controller 130, which are described above, are described in detail with reference to FIGS. 11 to 19.

FIG. 11 is a diagram schematically illustrating another example of a data processing system including a memory system in accordance with an embodiment. FIG. 11 schematically illustrates a memory card system 6100 to which the memory system may be applied.

Referring to FIG. 11, the memory card system 6100 may include a memory controller 6120, a memory device 6130 and a connector 6110.

More specifically, the memory controller 6120 may be electrically connected to, and configured to access, the memory device 6130 embodied by a nonvolatile memory (NVM). For example, the memory controller 6120 may be configured to control read, write, erase and background operations of the memory device 6130. The memory controller 6120 may be configured to provide an interface between the memory device 6130 and a host, and to use firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1.

Thus, the memory controller 6120 may include a random access memory (RAM), a processor, a host interface, a memory interface and an error correction component.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), wireless fidelity (Wi-Fi or WiFi) and Bluetooth. Thus, the memory system and the data processing system may be applied to wired/wireless electronic devices, including specific mobile electronic devices.

The memory device 6130 may be implemented by a nonvolatile memory (NVM). For example, the memory device 6130 may be implemented by any of various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM).

The memory controller 6120 and the memory device 6130 may be integrated into a single semiconductor device to form a solid-state driver (SSD). Also, the memory controller 6120 and the memory device 6130 may be so integrated to form a memory card such as a PC card (e.g., Personal Computer Memory Card International Association (PCMCIA) card), a compact flash (CF) card, a smart media card (e.g., a SM and a SMC), a memory stick, a multimedia card (e.g., a MMC, a RS-MMC, a MMCmicro and an eMMC), a secure digital (SD) card (e.g., a SD, a miniSD, a microSD and a SDHC), and/or a universal flash storage (UFS).

FIG. 12 is a diagram schematically illustrating another example of a data processing system 6200 including a memory system in accordance with an embodiment.

Referring to FIG. 12, the data processing system 6200 may include a memory device 6230 having one or more nonvolatile memories (NVMs) and a memory controller 6220 for controlling the memory device 6230. The data processing system 6200 illustrated in FIG. 12 may serve as a storage medium such as a memory card (e.g., CF, SD, micro-SD or the like) or USB device, as described with reference to FIG. 1. The memory device 6230 may correspond to the memory device 150 in the memory system 110 illustrated in FIG. 1, and the memory controller 6220 may correspond to the controller 130 in the memory system 110 illustrated in FIG. 1.

The memory controller 6220 may control a read, write or erase operation on the memory device 6230 in response to a request of the host 6210. The memory controller 6220 may include one or more central processing units (CPUs) 6221, a buffer memory such as a random access memory (RAM) 6222, an error correction code (ECC) circuit 6223, a host interface 6224 and a memory interface such as a nonvolatile memory (NVM) interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or vice versa. When the RAM 6222 is used as a cache memory, the RAM 6222 may assist the memory device 6230 to operate at higher speed.

The ECC circuit 6223 may correspond to the ECC component 138 of the controller 130 illustrated in FIG. 1. As described with reference to FIG. 1, the ECC circuit 6223 may generate an error correction code (ECC) for correcting a failed bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. The ECC circuit 6223 may correct an error using the parity bit. For example, as described with reference to FIG. 1, the ECC circuit 6223 may correct an error using the low density parity check (LDPC) code, Bose-Chaudhri-Hocquenghem (BCH) code, turbo code, Reed-Solomon (RS) code, convolution code, recursive systematic code (RSC) or coded modulation such as trellis coded modulation (TCM) or block coded modulation (BCM).

The memory controller 6220 may exchange data with the host 6210 through the host interface 6224. The memory controller 6220 may exchange data with the memory device 6230 through the NVM interface 6225. The host interface 6224 may be connected to the host 6210 through a parallel advanced technology attachment (PATA) bus, a serial advanced technology attachment (SATA) bus, a small computer system interface (SCSI), a universal serial bus (USB), a peripheral component interconnect-express (PCIe) or a NAND interface. The memory controller 6220 may have a wireless communication function with a mobile communication protocol such as wireless fidelity (WiFi) or long term evolution (LTE). The memory controller 6220 may be connected to an external device, for example, the host 6210 or another external device, and then exchange data with the external device. In particular, as the memory controller 6220 is configured to communicate with the external device according to one or more of various communication protocols, the memory system and the data processing system in accordance with an embodiment may be applied to wired/wireless electronic devices, particularly a mobile electronic device.

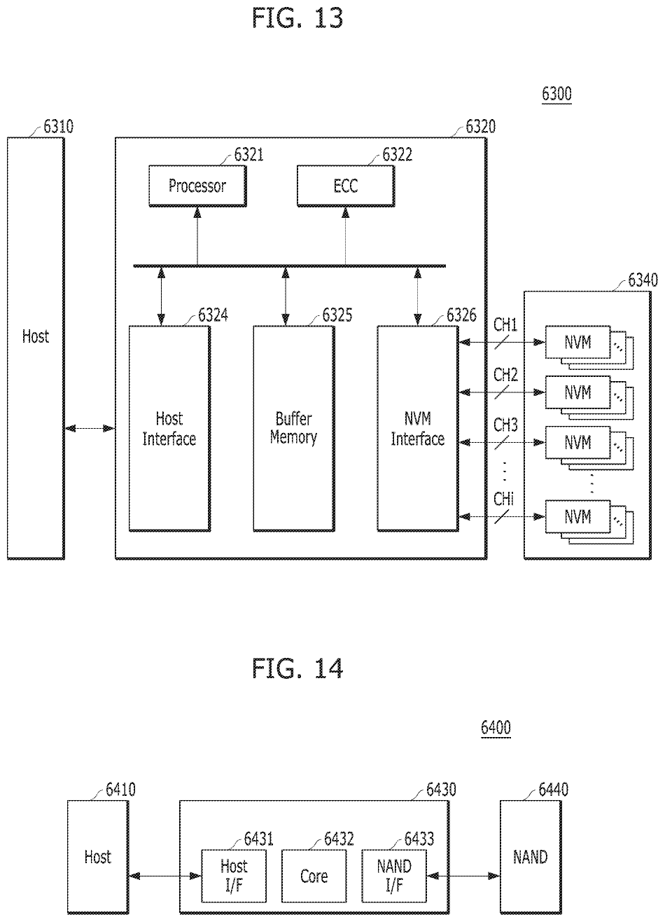

FIG. 13 is a diagram schematically illustrating another example of a data processing system including a memory system in accordance with an embodiment. FIG. 13 schematically illustrates a solid state drive (SSD) 6300 to which the memory system may be applied.

Referring to FIG. 13, the SSD 6300 may include a controller 6320 and a memory device 6340 including a plurality of nonvolatile memories (NVMs). The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, an error correction code (ECC) circuit 6322, a host interface 6324, a buffer memory 6325, and a memory interface, for example, a nonvolatile memory interface 6326.

The buffer memory 6325 may temporarily store data provided from the host 6310 or data provided from a plurality of flash memories NVM included in the memory device 6340. Further, the buffer memory 6325 may temporarily store meta data of the plurality of flash memories NUM, for example, map data including a mapping table. The buffer memory 6325 may be embodied by any of a variety of volatile memories such as a dynamic random access memory (DRAM), a synchronous DRAM (SDRAM), a double data rate (DDR) SDRAM, a low power DDR (LPDDR) SDRAM and a graphics RAM (GRAM) or nonvolatile memories such as a ferroelectric RAM (FRAM), a resistive RAM (RRAM or ReRAM), a spin-transfer torque magnetic RAM (STT-MRAM) and a phase-change RAM (PRAM). FIG. 13 illustrates that the buffer memory 6325 is embodied in the controller 6320. However, the buffer memory 6325 may be external to the controller 6320.

The ECC circuit 6322 may calculate an error correction code (ECC) value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 nr ay provide an interface function with the memory device 6340 connected through the plurality of channels.

Furthermore, a plurality of SSDs 6300 to which the memory system 110 of FIG. 1 may be applied may be provided to embody a data processing system, for example, a redundant array of independent disks (RAID) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 14 is a diagram schematically illustrating another example of a data processing system including a memory system in accordance with an embodiment. FIG. 14 schematically illustrates an embedded multi-media card (eMMC) 6400 to which the memory system may be applied.

Referring to FIG. 14, the eMMC 6400 may include a controller 6430 and a memory device 6440 embodied by one or more NAND flash memories. The controller 6430 may correspond to the controller 130 in the memory system 110 of FIG. 1. The memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, ultra high speed (UHS)-I/UHS-II) interface.

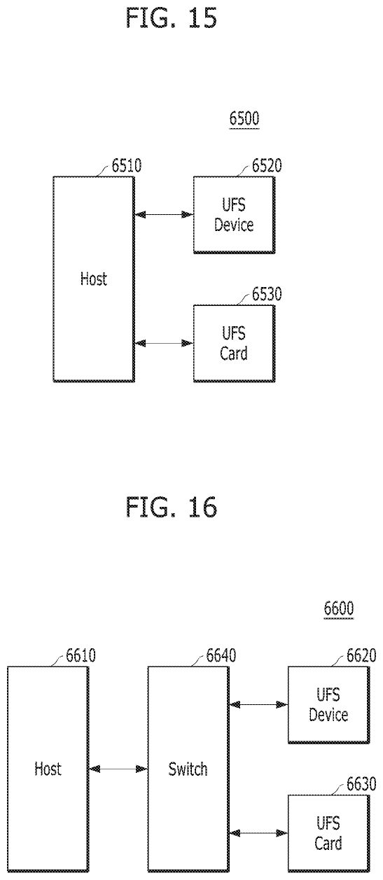

FIGS. 15 to 18 are diagrams schematically illustrating other examples of a data processing system including a memory system in accordance with embodiments. FIGS. 15 to 18 schematically illustrate universal flash storage (UFS) systems to which the memory system may be applied.

Referring to FIGS. 15 to 18, the UFS systems 6500, 6600, 6700, 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired/wireless electronic devices or particularly mobile electronic devices, the UFS devices 6520, 6620, 6720, 6820 may serve as embedded UFS devices, and the UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700, 6800 may communicate with external devices, for example, wired/wireless electronic devices or particularly mobile electronic devices through UFS protocols, and the UFS devices 6520, 6620, 6720, 6820 and the UFS cards 6530, 6630, 6730, 6830 may be embodied by the memory system 110 illustrated in FIG. 1. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 12 to 14, and the UFS cards 6530, 6630, 6730, 6830 may be embodied in the form of the memory card system 6100 described with reference to FIG. 11.

Furthermore, in the UFS systems 6500, 6600, 6700, 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI unified protocol (UniPro) in mobile industry processor interface (MIPI). Furthermore, the UFS devices 6520, 6620, 6720, 6820 and the UFS cards 6530, 6630, 6730, 6830 may communicate with each other through any of various protocols other than the UFS protocol, for example, universal storage bus (USB) Flash Drives (UFDs), a multi-media card (MMC), a secure digital (SD), a mini-SD, and a micro-SD.

In the UFS system 6500 illustrated in FIG. 15, each of the host 6510, the UFS device 6520 and the UFS card 6530 may include UniPro. The host 6510 may perform a switching operation to communicate with the UFS device 6520 and the UFS card 6530. In particular, the host 6510 may communicate with the UFS device 6520 or the UFS card 6530 through link layer switching, for example, L3 switching at the UniPro. The UFS device 6520 and the UFS card 6530 may communicate with each other through link layer switching at the UniPro of the host 6510. In the illustrated embodiment, one UFS device 6520 and one UFS card 6530 are connected to the host 6510. However, a plurality of UFS devices and UFS cards may be connected in parallel or in the form of a star to the host 6410. A star formation is an arrangement in which a single device is coupled with plural devices for centralized operation. A plurality of UFS cards may be connected in parallel or in the form of a star to the UFS device 6520 or connected in series or in the form of a chain to the UFS device 6520.

In the UFS system 6600 illustrated in FIG. 16, each of the host 6610, the UFS device 6620 and the UFS card 6630 may include UniPro. The host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the illustrated embodiment, one UFS device 6620 and one UFS card 6630 are connected to the switching module 6640. However, a plurality of UFS devices and UFS cards may be connected in parallel or in the form of a star to the switching module 6640. A plurality of UFS cards may be connected in series or in the form of a chain to the UFS device 6620.

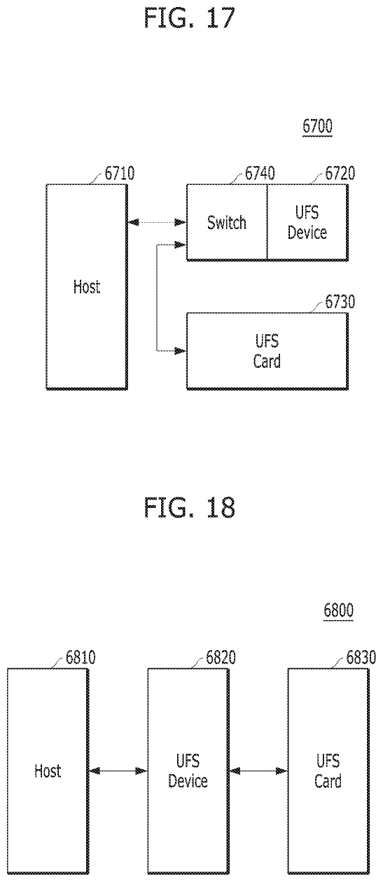

In the UFS system 6700 illustrated in FIG. 17, each of the host 6710, the UFS device 6720 and the UFS card 6730 may include UniPro. The host 6710 may communicate with the UFS device 6720 or the UFS card 6730 through a switching module 6740 performing a switching operation, for example, through the switching module 6740 which performs link layer switching at the UniPro, for example, L3 switching. The UFS device 6720 and the UFS card 6730 may communicate with each other through link layer switching of the switching module 6740 at the UniPro. The switching module 6740 may be integrated as one module with the UFS device 6720 inside or outside the UFS device 6720. In the illustrated embodiment, one UFS device 6720 and one UFS card 6730 are connected to the switching module 6740. However, a plurality of modules, each including the switching module 6740 and the UFS device 6720, may be connected in parallel or in the form of a star to the host 6710. In another example, a plurality of modules may be connected in series or in the form of a chain to each other. Furthermore, a plurality of UFS cards may be connected in parallel or in the form of a star to the UFS device 6720.

In the UFS system 6800 illustrated in FIG. 18, each of the host 6810, the UFS device 6820 and the UFS card 6830 may include M-PHY and UniPro. The UFS device 6820 may perform a switching operation to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target identifier (ID) switching operation. The host 6810 and the UFS card 6830 may communicate with each other through target ID switching between the M-PHY and UniPro modules of the UFS device 6820. In the illustrated embodiment, one UFS device 6820 is connected to the host 6810 and one UFS card 6830 is connected to the UFS device 6820. However, a plurality of UFS devices may be connected in parallel or in the form of a star to the host 6810, or connected in series or in the form of a chain to the host 6810. A plurality of UFS cards may be connected in parallel or in the form of a star to the UFS device 6820, or connected in series or in the form of a chain to the UFS device 6820.

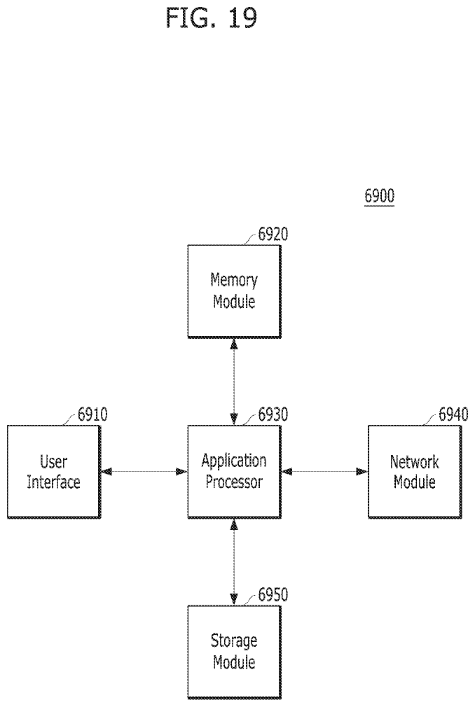

FIG. 19 is a diagram schematically illustrating another example of a data processing system including a memory system in accordance with an embodiment of the present invention. FIG. 19 is a diagram schematically illustrating a user system 6900 to which the memory system may be applied.

Referring to FIG. 19, the user system 6900 may include a user interface 6910, a memory module 6920, an application processor 6930, a network module 6940 and a storage module 6950.

More specifically, the application processor 6930 may drive components in the user system 6900, for example, an operating system (OS), and include controllers, interfaces and a graphic engine which control the components included in the user system 6900. The application processor 6930 may be provided as system-on-chip (SoC).

The memory module 6920 may be used as a main memory, work memory, buffer memory or cache memory of the user system 6900. The memory module 6920 may include a volatile random access memory (RAM) such as a dynamic RAM (DRAM), a synchronous DRAM (SDRAM), a double data rate (DDR) SDRAM, a DDR2 SDRAM, a DDR3 SDRAM, a low power DDR (LPDDR) SDARM, a LPDDR2 SDRAM or a LPDDR3 SDRAM or a nonvolatile RAM such as a phase-change RAM (PRAM), a resistive RAM (ReRAM), a magneto-resistive RAM (MRAM) or a ferroelectric RAM (FRAM). For example, the application processor 6930 and the memory module 6920 may be packaged and mounted, based on package on package (PoP).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (WiMAX), wireless local area network (WLAN), ultra-wideband (UWB), Bluetooth, wireless display (WI-DI), thereby communicating with wired/wireless electronic devices, particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, a NOR flash and a 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, an eMMC and an UFS as described above with reference to FIGS. 13 to 18.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired/wireless communication with an external device. The user interface 6910 may display data processed by the processor 6930 on a display/touch module of the mobile electronic device, or support a function of receiving data from the touch panel.

In accordance with embodiments of the present invention, since the read reclaim operation is performed on a victim block based on read counts of memory blocks instead of a host read amount, the frequency of the read reclaim operation may be adjusted considering an actual extent of damage of the memory blocks.

While the present invention has been illustrated and described with respect to specific embodiments, it will be apparent to those skilled in the art in light of the present disclosure that various changes and modifications may be made without departing from the spirit and scope of the invention as defined in the following claims.

What is claimed is:

1. A memory system comprising:
a memory device including a plurality of dies, each including one or more flush blocks and one or more multi-level cell blocks;
a controller write buffer;
a controller buffer manager configured to buffer host data into the controller write buffer;
a flush block manager configured to control, when a flush command is received, the memory device to perform an interleaved program operation of programming the buffered host data into the flush blocks respectively included in the dies; and
a processor configured to control, when a size of the buffered host data reaches a threshold value, the memory device to perform the interleaved program operation of programming the buffered host data into the multi-level cell blocks respectively included in the dies.

2. The memory system of claim 1, wherein the threshold value is a product of the number of the dies and a capacity of a multi-level cell page.

3. The memory system of claim 1, wherein the threshold value is a multiple of a product of the number of the dies and a capacity of a multi-level cell page.

4. The memory system of claim 3, wherein the controller write buffer has a greater capacity than the threshold value.

5. The memory system of claim 1, wherein the flush block manager is further configured to divide the buffered host data and configured to control the memory device to perform a program operation of simultaneously programming the divided host data into the flush blocks respectively included in the dies.

6. The memory system of claim 1, wherein the processor is further configured to divide the buffered host data and configured to control the memory device to perform a program operation of simultaneously one-shot-programming the divided host data into the multi-level cell blocks respectively included in the dies.

7. The memory system of claim 1, wherein the controller write buffer includes a volatile memory.

8. The memory system of claim 1, wherein the multi-level cell blocks include triple level cell blocks.

9. The memory system of claim 1, wherein the buffered host data is kept buffered even after programmed into the flush blocks.

10. The memory system of claim 1, wherein the flush blocks include single level cell blocks.

11. An operating method of a memory system, the method comprising:
buffering host data into a controller write buffer;
performing, when a flush command is received, a first interleaved program operation of programming the buffered host data into a plurality of flush blocks respectively included in a plurality of dies; and
performing, when a size of the buffered host data reaches a threshold value, a second interleaved program operation of programming the buffered host data into a plurality of multi-level cell blocks respectively included in the dies.

12. The method of claim 11, wherein the threshold value is a product of the number of the dies and a capacity of a multi-level cell page.

13. The method of claim 11, wherein the threshold value is a multiple of a product of the number of the dies and a capacity of a multi-level cell page.

14. The method of claim 13, wherein the controller write buffer has a greater capacity than the threshold value.

15. The method of claim 11, wherein the performing of the first interleaved program operation includes dividing the buffered host data and performing a program operation of simultaneously programming the divided host data into the flush blocks respectively included in the dies.

16. The method of claim 11, wherein the performing of the second interleaved program operation includes dividing the buffered host data and performing a program operation of simultaneously one-shot-programming the divided host data into the multi-level cell blocks respectively included in the dies.

17. The method of claim 11, wherein the controller write buffer includes a volatile memory.

18. The method of claim 11, wherein the multi-level cell blocks include triple level cell blocks

19. The method of claim 11, wherein the buffered host data is kept buffered even after programmed into the flush blocks.

20. The method of claim 11, wherein the flush blocks include single level cell blocks.
